(19) United States
(12) Patent Application Publication
(10) Pub. No.: US 2023/0075026 A1
(43) Pub. Date: Mar. 9, 2023

(54) Online Experiment Randomization Evaluation

(71) Applicant: eBay Inc., San Jose, CA (US)

(72) Inventors: Zezhong Zhang, Campbell, CA (US); Keyu Nie, Mountain View, CA (US); Ted Tao Yuan, Cupertino, CA (US)

(73) Assignee: eBay Inc., San Jose, CA (US)

(21) Appl. No.: 17/406,393

(22) Filed: Aug. 19, 2021

(51) Int. Cl. G06F 17/18; G06F 8/71; G06K 9/62

(52) U.S. Cl. CPC G06F 17/18; G06F 8/71; G06K 9/6215; G06K 9/6265; G06F 9/451

(57) ABSTRACT

An online experiment system is described that generates a randomization evaluation for an online experiment, while the experiment is ongoing, indicating whether a distribution of experiment participants allocated to one or more participant groups satisfies an expected distribution. The online experiment system analyzes one of the experiment groups to obtain an observed distribution of the subset of experiment participants included in the experiment group. The online experiment system then evaluates the observed distribution relative to the expected distribution for the experiment according to a decision criteria of a population stability index test. The decision criteria is influenced by a tuning parameter that represents a ratio of experiment participants included in the observed experiment group to experiment participants included in a different experiment group. Responsive to the randomization evaluation indicating that a current distribution of experiment participants fails to satisfy the expected distribution for the experiment, an alert is output.

### BACKGROUND

Randomized controlled trials are often used to conduct experiments when important variables cannot be brought under direct experimental control. For instance, experiment participants differ from one another in many ways, and different attributes that define these participants influence experiment results yet cannot be directly controlled. To mitigate bias that results from such uncontrollable variables, experiment participants are randomly allocated among different groups, or “buckets,” before being provided with an experiment control or treatment, which provides a degree of statistical control over the influence of uncontrollable variables. With this statistical control, experiment results can be reliably used to derive comparisons between the experiment control and treatment, despite the impact of uncontrollable variables in different participant buckets. However, such statistical control is dependent on proper randomization, as even slight randomization issues can result in unreliable experiment results. Consequently, trustworthy experiments require verifying that participants were randomly distributed to ensure reliable results.

### SUMMARY

An online experiment system is described that generates a randomization evaluation for an online experiment, which indicates whether a distribution of experiment participants allocated to one or more experiment buckets satisfies an expected distribution for the experiment. To do so, the online experiment system implements a population stability index (PSI) test by first analyzing one of the experiment buckets to obtain an observed distribution of the subset of experiment participants included in the experiment bucket. The online experiment system then evaluates the observed distribution relative to the expected distribution for the experiment according to a decision criteria of the PSI test.

In implementations, the decision criteria is influenced by a tuning parameter that represents a ratio of a number of experiment participants included in the experiment bucket from which the observed distribution was derived to a number of experiment participants included in a different experiment bucket. The online experiment system is configured to generate the randomization evaluation while an experiment is ongoing and utilize the randomization evaluation to trigger output of an alert in response to detecting that a current distribution of experiment participants fails to satisfy the expected distribution for the experiment.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In some implementations, entities represented in the figures are indicative of one or more entities and thus reference is made interchangeably to single or plural forms of the entities in the discussion.

FIG. 1 is an illustration of an environment in an example implementation that is operable to employ an online experiment system to generate a randomization evaluation indicating whether an allocation of experiment participants into different experiment buckets achieves an expected distribution for the experiment.

FIG. 2 depicts a system in an example implementation showing operation of the online experiment system of FIG. 1 in greater detail.

FIG. 3 depicts a system in an example implementation showing operation of the online experiment system of FIG. 1 in greater detail.

FIG. 4 depicts an example implementation showing operation of a distribution validation module of the online experiment system of FIG. 1 in greater detail.

FIG. 5 is a flow diagram depicting a procedure in an example implementation in which a computing device outputs a randomization evaluation describing whether testing groups represent a desired distribution of experiment participants.

FIG. 6 illustrates an example system including various components of an example device to implement the techniques described with reference to FIGS. 1-5.

### DETAILED DESCRIPTION

Overview

Entities utilize online controlled experiments to evaluate how various changes will impact an overall experience with one or more online services associated with the entities. Online controlled experiments are used to evaluate user response to different aspects such as user interface changes, relevance algorithms (e.g., search algorithms, personalization algorithms, recommendation algorithms, etc.), latency and performance issues, content management system, customer support systems, and so forth. Online controlled experiments can be used to evaluate a single change across multiple channels, such as websites, desktop applications, mobile applications, email, and the like.

A crucial aspect to ensuring that reliable test results are generated from these online controlled experiments is proper randomization of experiment participants into different testing groups. By randomly separating participants in a uniform manner, different testing groups are ensured to have a degree of statistical similarity, allowing causal effects to be determined with a high probability of accuracy. In this manner, “randomly” assigning participants to different testing groups does not refer to haphazard allocation, but rather to a deliberate allocation based on probabilities. Participants are randomly allocated based on different randomization units, such as by user profiles, by computing device identifiers, and so forth.

Online experiment participants differ from one another in many ways, and different attributes that define these participants, but cannot be controlled, influence experiment results. Random allocation ensures a degree of statistical control over the influence of uncontrollable variables. With this statistical control, experiment results can be reliably used to derive comparisons between the experiment control and treatment, despite the impact of uncontrollable variables in different participant buckets. Consequently, it is dangerous to run experiments with potential randomization issues due to the unreliable nature of results obtained from such experiments.

Conventional approaches to assessing participant randomization employ statistical test methods such as the Pearson Chi-square test, the Kolmogorov-Smirnov test, and the Anderson-Darling test. However, these conventional approaches suffer from significant drawbacks by consistently generating false positive and false negative results when applied to random distribution analyses, which impact the effectiveness of randomization validation. When extended to scale, such as to concurrently running millions of online experiments that each evaluate responses of millions of users, these conventional drawbacks impede the overall testing pipeline by requiring manual user intervention to verify the accuracy of false positive and false negative reports.

To address these issues, techniques for generating a randomization evaluation using a population stability index (PSI) test are described. An online experiment system outputs the randomization evaluation, which indicates whether a distribution of online experiment participants satisfies an expected distribution (e.g., a random uniform distribution) for the online experiment.

To do so, the online experiment system implements a (PSI) test by analyzing one of the testing groups to which experiment participants are allocated and evaluates an observed distribution of the testing group relative to the expected distribution for the experiment according to a decision criteria of the PSI test. The decision criteria is influenced by a tuning parameter that represents a ratio of a number of online experiment participants included in the analyzed testing group relative to a number of online experiment participants included in a different testing group. The online experiment system is configured to generate the randomization evaluation while an online experiment is ongoing and utilize the randomization evaluation to trigger output of an alert in response to detecting that a current distribution of experiment participants fails to satisfy the expected distribution for the experiment.

Relative to the statistical test methods employed by conventional approaches, the PSI test employed according to the techniques described herein output significantly fewer false positives and false negatives. In addition to this increased effectiveness relative to conventional approaches, the techniques described herein identify randomization anomalies more efficiently than conventional approaches, achieving a highest precision score, recall score, and overall measure of test accuracy when evaluated relative to conventional statistical test methods. The techniques described herein are not only configured to increase the efficiency and effectiveness of online experimentation randomization validation, but also improve a degree of confidence in the results generated by online experiments. Further discussion of these and other examples is included in the following sections and shown in corresponding figures.

In the following discussion, an example environment is described that is configured to employ the techniques described herein. Example procedures are also described that are configured for performance in the example environment as well as other environments. Consequently, performance of the example procedures is not limited to the example environment and the example environment is not limited to performance of the example procedures.

Example Environment

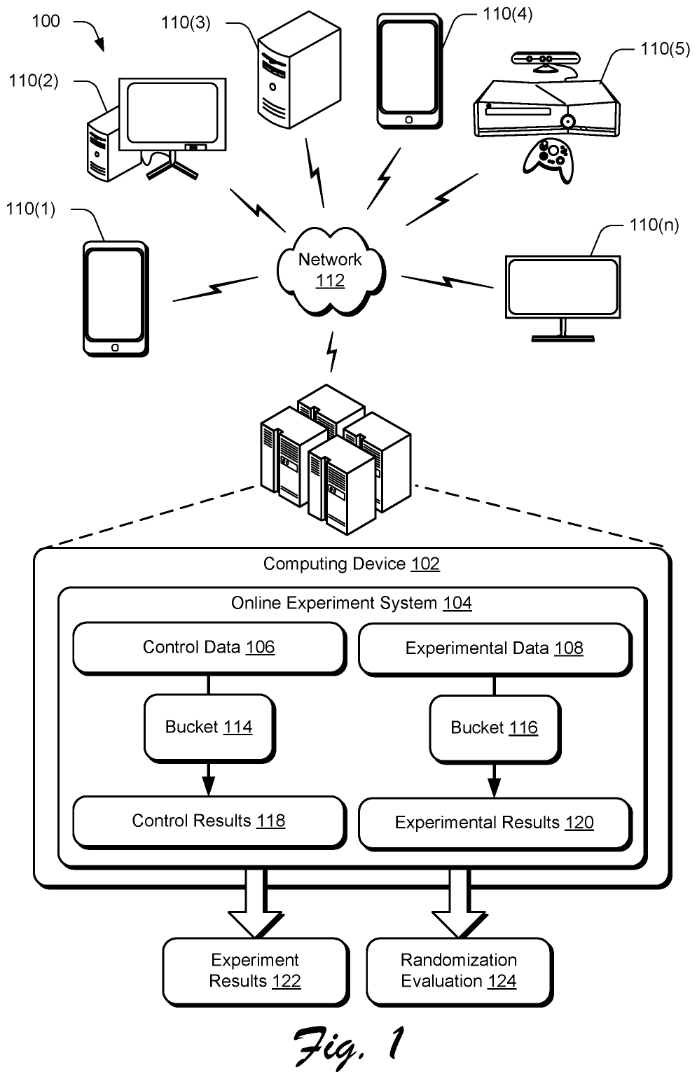

FIG. 1 is an illustration of a digital medium environment 100 in an example implementation that is operable to employ techniques described herein. As used herein, the term “digital medium environment” refers to the various computing devices and resources utilized to implement the techniques described herein. The digital medium environment 100 includes a computing device 102, which is configurable in a variety of manners.

The computing device 102, for instance, is configurable as a desktop computer, a laptop computer, a mobile device (e.g., assuming a handheld or wearable configuration such as a tablet or mobile phone), and so forth. Thus, the computing device 102 ranges from full resource devices with substantial memory and processor resources (e.g., personal computers, game consoles) to low-resource devices with limited memory and/or processing resources (e.g., mobile devices). Additionally, although described in the context of a single computing device 102, the computing device 102 is representative of a plurality of different devices, such as multiple servers utilized to perform operations “over the cloud.”

In the illustrated example, the computing device 102 includes an online experiment system 104. The online experiment system 104 is representative of functionality of the computing device to conduct an experiment by providing control data 106 to a first subset of experiment participants and experimental data 108 to a second subset of experiment participants. In accordance with one or more implementations, online experiment participants are represented by computing devices 110, such as computing device 110(1), computing device 110(2), computing device 110(3), computing device 110(4), computing device 110(5), and computing device 110(n) in the illustrated example of FIG. 1, where n is representative of any suitable integer (e.g., an online experiment can include billions of participants). The computing devices 110 are illustrated as being configured differently from one another, such that different experiment participants may be different device types (e.g., mobile device, television, desktop device, server, etc.), similar device types with different operating parameters (e.g., mobile devices with different operating systems, network connection types, web browser types being used, etc.), different user profiles associated with a single device, different sites or pages used to access a resource (e.g., digital content), combinations thereof, and so forth. In this manner, the computing devices 110 are representative of different experiment participants that can be distinguished from one another based on one or more attributes, and references herein to experiment participants are not so limited to computing devices.

To facilitate the online experiment, the online experiment system 104 provides control data 106 to one or more subsets of the experiment participants (e.g., one or more subsets of the computing devices 110) and experimental data 108 to one or more different subsets of the experiment participants. In an example where the online experiment is configured to test an update to a user interface (e.g., a website), the control data 106 represents a currently implemented version of the user interface and the experimental data 108 represents the updated version of the user interface. Various examples of experimental user interface changes include varying colors for a single user interface element, altering a message displayed in a user interface, changing a layout of a subset of elements included in a user interface, implementing different algorithms that populate digital content in one or more portions of a user interface, and so forth. Although described in the context of a user interface web site, the online experiment system 104 is configured to perform the randomization evaluation techniques described herein for any experiment type.

In the illustrated example of FIG. 1, the control data 106 and the experimental data 108 are provided by the online experiment system 104 to the experiment participants via network 112. For instance, in an example implementation where the experiment is configured to evaluate a response to a website user interface update, a first subset of the computing devices 110 is provided with a current version of the user interface and a second subset of the computing devices 110 is provided with an updated version of the user interface in response to requesting the website (e.g., navigating to the website via a web browser).

Continuing this example, the first subset of the computing devices 110 is represented as bucket 114 and the second subset of the computing devices 110 is represented as bucket 116. Although only two “buckets” of experiment participants are depicted in the illustrated example of FIG. 1, the online experiment system 104 is configured to conduct experiments that allocate experiment participants represented by the computing devices 110 to any number of different buckets, and the techniques described herein are not so limited to the illustrated example of FIG. 1.

The online experiment system 104 is configured to monitor a response of the computing devices 110 included in the bucket 114 to the control data 106 to obtain control results 118. In a similar manner, the online experiment system 104 is configured to monitor a response of the computing devices 110 included in the bucket 116 to the experimental data 108 to obtain experimental results 120. The control results 118 and the experimental results 120 are representative of any measurable data that is designated for observation as part of an experiment being conducted by the online experiment system 104. For instance, in an example implementation where the control data 106 represents a first version of a website user interface and the experimental data 108 represents a second version of the website user interface, the control results 118 and the experimental results 120 may be representative of a download time for the different website user interface versions, a time spent by experiment participants interacting with the different website user interface versions (e.g., measures of interaction with a specific user interface element presented using different colors, measures of time spent with a message portion of a user interface in focus, measures of interactions with digital content items populated using different algorithms, etc.), a load on a server hosting the respective website user interface version, and so forth.

The online experiment system 104 is configured to aggregate the control results 118 and the experimental results 120 to generate experiment results 122 for the experiment being conducted. To ensure that the experiment results 122 are reliable, the online experiment system 104 is configured to output a randomization evaluation 124. The randomization evaluation 124 is representative of a report that includes information describing whether a distribution of experiment participants (e.g., of the computing devices 110) included in one or more of the subsets into which the participants were allocated for the experiment (e.g., one or more of the bucket 114 or the bucket 116) satisfies an expected distribution for the experiment. For instance, in an example implementation where the computing devices 110 are randomly allocated into one of bucket 114 or bucket 116 the expected distribution may be that the computing devices 110 are evenly distributed, such that bucket 114 and bucket 116 not only include a same number of the computing devices 110, but also that attributes of the computing devices 110 included in bucket 114 are similarly represented in bucket 116.

As described in further detail below, the online experiment system 104 is configured to generate the randomization evaluation 124 during performance of the experiment (e.g., prior to output of the experiment results 122). Because a reliability of an experiment depends on an actual allocation of experiment participants following an expected distribution for the experiment, the randomization evaluation 124 is critical in ensuring trustworthiness of the experiment results 122. The randomization evaluation 124 is useable in implementations to alert an entity conducting an experiment as to potential randomization issues that would affect a reliability of the experiment results 122, enabling early intervention and correction of the randomization issues prior to completion of the experiment. For instance, the randomization evaluation 124 is configured to output an alert recommending redistribution of the computing devices 110 among the experiment buckets in in response to detecting that a current distribution of the computing devices 110 fails to represent an expected or desired distribution of the computing devices 110 during the experiment. Further examples of online experiments and online experiment considerations that are negatively impacted by randomization issues are described in International Patent Application No. PCT/CN2019/096663, titled “Sample Delta Monitoring,” the disclosure of which is hereby incorporated by reference.

In general, functionality, features, and concepts described in relation to the examples above and below are employable in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are configured to be applied together and/or combined in different ways. Thus, individual functionality, features, and concepts described in relation to different example environments, devices, components, figures, and procedures herein are useable in any suitable combinations and are not limited to the combinations represented by the enumerated examples in this description.

Randomization Evaluation for Online Experiments

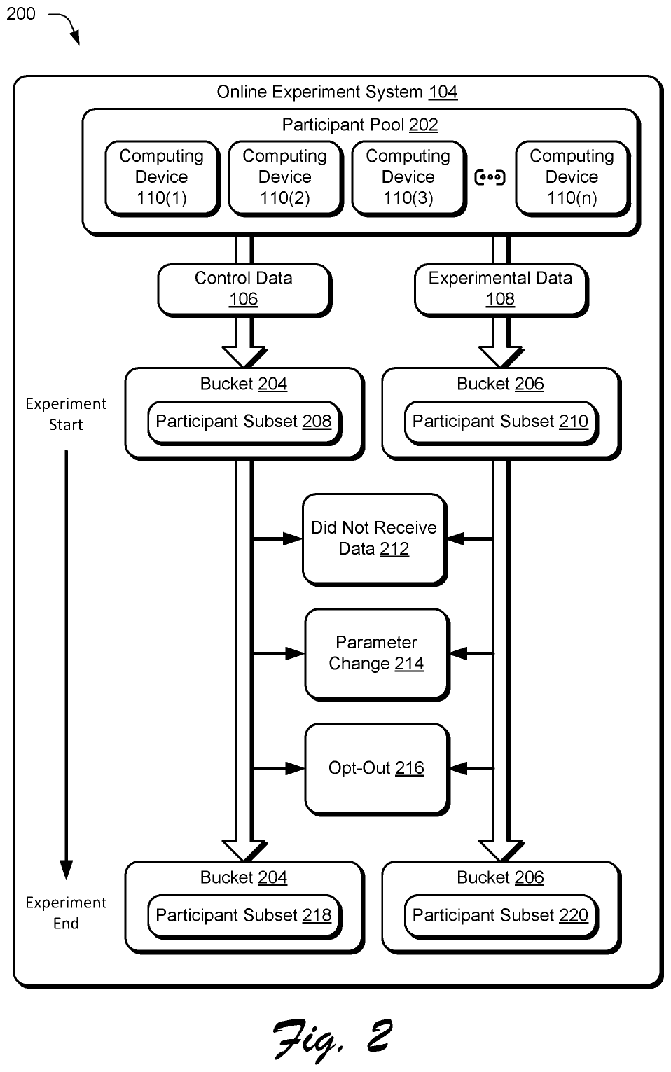

FIG. 2 is an illustration of a digital medium environment 200 in an example implementation of the online experiment system 104 conducting an experiment by allocating participants to different buckets, where a subset of participants initially allocated to a bucket change while the experiment is ongoing.

In the illustrated example, the online experiment system 104 is configured to conduct an online experiment with a participant pool 202 that includes a plurality of experiment participants, represented as n different computing devices 110. The online experiment system 104 is configured to allocate members of the participant pool 202 to a plurality of buckets, represented by bucket 204 and bucket 206 in the example implementation of FIG. 2. Although illustrated as being allocated to only two buckets in the illustrated example, the online experiment system 104 is configured to allocate members of the participant pool 202 to any number of buckets, such as tens of buckets, hundreds of buckets, and so forth.

In this manner, each of the plurality of buckets includes a subset of the experiment participants, which is represented as participant subset 208 included in bucket 204 and participant subset 210 included in bucket 206. The online experiment system 104 is configured to initiate the experiment by providing control data 106 to the participant subset 208 included in bucket 204 and providing experimental data 108 to the participant subset 210 included in participant subset 208. A duration during which a response of experiment participants is monitored varies based on the requirements of the particular experiment being conducted. For instance, an online experiment may be configured to last hours, days, weeks, months, and so forth.

In contrast to experiments where participants are identifiable as individual human subjects, such as a pharmaceutical trial where an individual participant is placed in a room and visually monitored to determine their response to a drug, online experiment participants are subject to substantially more changes that can impact how a participant's response is represented in experiment results. For instance, while a human subject in a pharmaceutical trial might be subject to minor characteristic fluctuations during the course of the experiment (e.g., weight changes) other variables such as the participant's height, gender, age, and the like are guaranteed to remain constant during the course of the experiment. In contrast to human subjects, computing device participants in online experiments are guaranteed to maintain few constant attributes (e.g., computing device type) and are subject to many attribute changes during the course of the experiment, such as changes to network connection types, changes in network connection speeds, changes in computing device processing loads, changes in currently active applications, changes in user profiles logged onto the computing device, and so forth.

For instance, in the example implementation of FIG. 2, various events are illustrated as representative of incidents that may affect characteristics of one or more participants included in the participant subset 208 and/or participant subset 210. Event 212, for instance, is representative of one or more of the computing devices 110 not receiving data (e.g., one or more of the computing devices 110 included in the participant subset 208 not receiving the control data 106, one or more of the computing devices 110 included in the participant subset 210 not receiving the experimental data 108, or combinations thereof). In such an example occurrence of event 212, computing devices that are included in the participant subset 208 or the participant subset 210 are unable to provide a response to the respective control data 106 or experimental data 108 that was not received, and thus need to be removed from the respective bucket 204 or bucket 206 to avoid improper bias in experiment results.

Event 214 is representative of a parameter change for one or more of the computing devices 110 included in the participant subset 208, the participant subset 210, or combinations thereof. For instance, in an example implementation where the control data 106 and the experimental data 108 represent different versions of a website user interface being tested as part of an experiment, a participant computing device may switch from viewing the website user interface in a first web browser to a second web browser while the experiment is ongoing (e.g., during the monitoring of a response to the computing device accessing the respective version of the website user interface).

As another example, a parameter change event 214 occurs when a participant computing device experiences a change in network connection, such as transferring between wireless network connections, experiencing a change in network connection speed, and so forth. As yet another example, a parameter change event 214 occurs when a participant computing device experiences a change in processing load, such as running additional applications, closing previously executing applications, initiating a load-intensive event (e.g., videoconferencing, movie playback, digital media upload), combinations thereof, and so forth. A parameter change event 214 is significant in the context of an online experiment because reliable experiment results often depend on different buckets (e.g., bucket 204 and bucket 206) including participant subsets that each represent similar parameter distributions.

As yet another example, event 216 is representative of one or more of the computing devices 110 included in the participant subset 208, the participant subset 210, or combinations thereof ending participation in the online experiment prior to completion of the experiment. An opt-out event 216 is thus representative of a computing device participant losing a network connection and thus being unable to continue accessing the control data 106 or the experimental data 108, of a user of the computing device participant deciding to cease viewing or otherwise interacting with the control data 106 or the experimental data 108, and the like. In such an example occurrence of event 216, responses obtained from computing devices that are included in the participant subset 208 or the participant subset 210 to the respective control data 106 or experimental data 108 will not comprehensively represent an actual response to the control data 106 or the experimental data 108, and the participants subject to the opt-out event 216 thus need to be removed from the respective bucket 204 or bucket 206 to avoid improper bias in experiment results.

Occurrence of events represented by events 212, 214, and 216 while an online experiment is ongoing causes the participant subset included in bucket 204 to change from participant subset 208 at the beginning of the experiment to participant subset 218 at the end of the experiment. Likewise, these example and other events cause the participant subset 210 included in bucket 206 at the start of the experiment to change to participant subset 220 at the end of the experiment. Such changes in participant subsets are representative of removal of participants included in the original participant subset 208 or participant subset 210, addition of participants to the subset 218 or the subset 220 not included in the original participant subsets, changes to attributes of individual participants from a configuration as represented in the original participant subsets, combinations thereof, and so forth. Consequently, online experiments are subject to numerous variable changes that must be monitored and accounted for to ensure reliable experiment results.

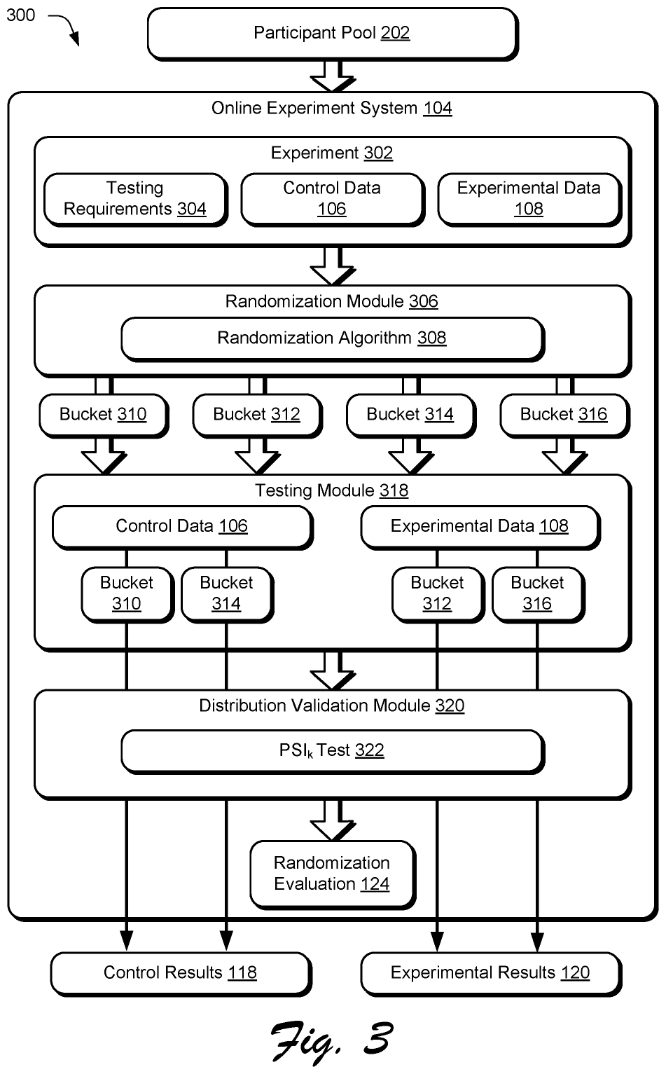

FIG. 3 is an illustration of a digital medium environment 300 in an example implementation of the online experiment system 104 conducting an online experiment by randomly allocating participants into different buckets, providing control data 106 and experimental data 108 to different ones of the buckets, and generating a randomization evaluation 124 for at least one of the buckets while the experiment is in progress.

In the illustrated example, the online experiment system 104 is configured to conduct an experiment 302, which is defined by testing requirements 304 that describe control data 106 and experimental data 108 that are to be provided to members of a participant pool 202 in conducting the experiment. In some implementations, the testing requirements 304 additionally describe a manner in which members of the participant pool 202 are to be allocated to different experiment buckets as well as which ones of the experiment buckets are to receive the control data 106 and which ones of the experiment buckets are to receive the experimental data 108. The testing requirements 304 may additionally describe attributes of the participant pool 202 members that are to be considered in ensuring a proper distribution among the experiment buckets and information to be gathered as part of generating experiment results 122.

To conduct the experiment 302, the online experiment system 104 is configured to pass the participant pool 202 to a randomization module 306. The randomization module 306 includes a randomization algorithm 308 that is configured to randomly allocate members of the participant pool 202 to a plurality of different experiment buckets, as defined by the testing requirements 304. The randomization algorithm 308 is representative of any suitable type of randomization algorithm, such as a hashing function (e.g., an MD5 hashing function) in combination with a math modulo that randomly maps members of the participant pool 202 into different experiment buckets uniformly in a random manner.

For instance, the randomization algorithm 308 may be represented as Hash(x,seed) mod B˜U(0,B), where x represents the identifier of an experiment participant (e.g., one of the computing devices 110 included in the participant pool 202), mod is the arithmetic modulo operator, Hash(x,seed) is the hashing function with a randomization seed, and B is the total number of experiment buckets. FIG. 3 depicts an example implementation where the randomization algorithm 308 is configured to randomly and uniformly allocate members of the participant pool 202 to four different experiment buckets, represented as bucket 310, bucket 312, bucket 314, and bucket 316. Although described in the context of uniformly allocating the participant pool 202 into different experiment buckets, such that each of the buckets 310, 312, 314 and 316 include an equal number of participant pool 202 members and similar distributions of participant pool 202 member attributes, in some implementations the randomization algorithm 308 is configured to unevenly allocate participant pool 202 members to different experiment buckets.

For instance, in some implementations the testing requirements 304 may specify that the randomization algorithm 308 include a first number of participant pool 202 members in bucket 310, a second number of participant pool 202 members in bucket 312, a third number of participant pool 202 members in bucket 314, and a fourth number of participant pool 202 members in bucket 316. In such an uneven distribution implementation, the testing requirements 304 may be configured to cause the randomization algorithm 308 to maintain a similar distribution of participant pool 202 member attributes among the different buckets 310, 312, 314, and 316, despite different ones of the experiment buckets including a different overall number of participant pool 202 members.

The online experiment system 104 includes a testing module 318, which is configured to administer the control data 106 and the experimental data 108 to members of the experiment buckets as allocated by the randomization module 306. For instance, in the illustrated example of FIG. 3, the testing requirements 304 cause the testing module 318 to administer the control data 106 to participant pool 202 members allocated to bucket 310 and bucket 314 and administer the experimental data 108 to participant pool 202 members allocated to bucket 312 and bucket 316.

The testing module 318 is further configured to output control results 118 by monitoring and recording one or more responses caused by administration of the control data 106 to participant pool 202 members allocated to bucket 310 and bucket 314. Similarly, the testing module 318 is configured to output experimental results 120 by monitoring and recording one or more responses caused by administration of the experimental data 108 to participant pool 202 members allocated to bucket 312 and bucket 316. Specific responses monitored by the testing module 318 in generating the control results 118 and the experimental results 120 are defined by the testing requirements 304 for the experiment 302.

The online experiment system 104 further includes a distribution validation module 320, which is representative of functionality of the online experiment system 104 to generate a randomization evaluation 124 indicating whether a distribution of participant pool 202 members allocated to one of the buckets 310, 312, 314, or 316 satisfies an expected distribution as defined by the testing requirements 304.

For instance, in an example implementation where the expected distribution for members of the participant pool 202 is an equal and uniform distribution among the buckets 310, 312, 314, and 316, the expected distribution can be modeled by Hypothesis One (H₁) and Hypothesis Two (H₂):

$${H}_{1} : ∀ b ∈ [ 0 , B ) , {p}_{b} = \frac{1}{B}$$

$${H}_{2} : ∃ b ∈ [ 0 , B ) , {p}_{b} \neq \frac{1}{B}$$

Under these hypotheses, N_{b} represents participant pool 202 members included in one of the experiment buckets, such as participant pool 202 members allocated to bucket 312, such that a total number of the participant pool 202 members is represented as N=Σ_{b=0}^{B-1}N_{b}. A test for whether the distribution of participant pool 202 members allocated to bucket 312 matches a

$$\frac{1}{B}$$

uniform distribution can be tested using the hypotheses, where the observed distribution of participant pool 202 members allocated to bucket 312 is represented as

$${\hat{p}}_{b} = \frac{{N}_{b}}{N} .$$

In order to output a randomization evaluation 124 without false positive or false negative results, the distribution validation module 320 is configured to implement a PSIₖ test 322, which is representative of a single experiment bucket test for determining whether participant pool 202 members included in an experiment bucket represents an even distribution of the participant pool 202. Advantageously, the PSIₖ test 322 is configured for administration by the distribution validation module 320 while the experiment 302 is ongoing (e.g., prior to output of the control results 118 or the experimental results 120).

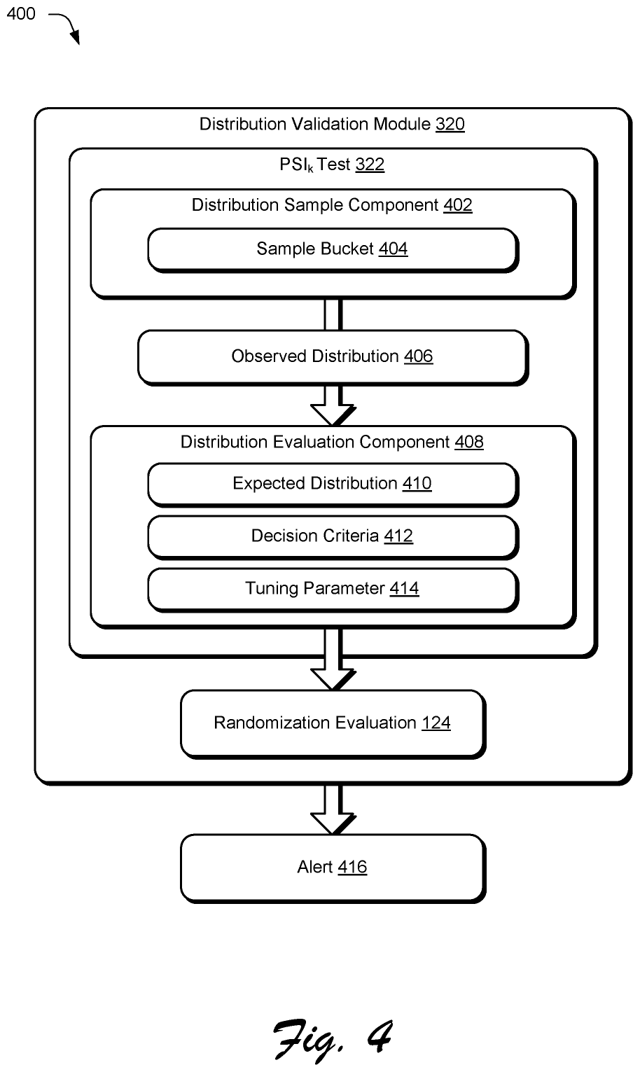

Although described in the context of being implemented as a single experiment bucket test to verify appropriate sample distribution (e.g., experiment participant distribution), the PSIₖ test 322 is further extendable to evaluate and compare any other measurable aspect of an experiment, such as a performance measurement. For instance, in an implementation where a group of experiment participants provided with experimental data 108 are distributed among a plurality of buckets, the PSIₖ test 322 is extendable to determine whether the experiment participants exhibit a common response, quantified by a performance measurement, to the experimental data 108 by extrapolating the assumption that performance metrics for the experiment participants should be the same among buckets exposed to the experimental data. In implementations, the PSIₖ test 322 is configured to evaluate an even distribution of participant pool 202 members by conducting multiple experiment bucket tests, such as a single experiment bucket test determining whether participant pool 202 members included in an experiment bucket represents an even distribution of the participant pool 202 in combination with one or more tests verifying that performance measurements are similar among buckets of participant pool 202 members exposed to one of the control data 106 or the experimental data 108. For a detailed description of generating the randomization evaluation 124 using the PSIₖ test 322, consider FIG. 4.

FIG. 4 is an illustration of a digital medium environment 400 in an example implementation of the distribution validation module 320 implementing the PSIₖ test 322 to generate a randomization evaluation 124 for an online experiment.

In the illustrated example, the distribution validation module 320 is depicted as implementing the PSIₖ test 322 to generate the randomization evaluation 124 for an online experiment being conducted by the online experiment system 104. The PSIₖ test 322 extrapolates fundamentals of the PSI statistic, originally designed to measure how much a variable shifts over time. For two different sample populations with respective sample counts n and m, \hat{p}_{b} represents the proportion of sample n in an experiment bucket b and \hat{q}_{b} represents the proportion of sample m in the experiment bucket b. The PSI statistic compares sample counts in different experiment buckets to determine whether the different experiment buckets include a same distribution of the two different sample populations.

The PSI statistic is known to have a distribution that is approximated by

$$( \frac{1}{n} + \frac{1}{m} )$$

times a random variable χ² with B−1 degrees of freedom, as indicated below in Equations 1 and 2:

$$PSI = {\sum }_{0}^{B} ( {\hat{p}}_{b} - {\hat{q}}_{b} ) ln \frac{{\hat{p}}_{b}}{{\hat{q}}_{b}} \qquad ( Eq . 1 )$$

$$PSI \sim ( \frac{1}{n} + \frac{1}{m} ) {χ}_{B - 1}^{2} \qquad ( Eq . 2 )$$

For the two different sample populations with respective sample counts n and m, let m=kn with k∈ [symbol] ⁺ representing the ratio of total sample counts in the two sample populations. The PSIₖ test 322 adopts the PSI statistic to a single sample distribution test under the presumption that the randomization evaluation 124 is configured to verify a uniform distribution of participant pool 202 members among different experiment buckets, such that m=n for a scenario where the different experiment buckets each include an equal number of the participant pool 202 members. Under this presumption, k becomes an extra tuning parameter that represents a ratio of a number of experiment participants included in an experiment bucket relative to number of experiment participants included in a different experiment bucket.

The PSIₖ test 322 thus implements a distribution sample component 402 that is configured to analyze a single sample bucket 404, which is representative of one of the experiment buckets generated by the randomization module 306, such as one of buckets 310, 312, 314, or 316 as depicted in FIG. 3. The distribution sample component 402 outputs an observed distribution 406, \hat{p}_{b}, for the single sample bucket 404 denoting a number of experiment participants included in the single sample bucket 404, which can be represented as N_{b}. With the total participant pool 202 being defined as N=Σ_{b=0}^{B-1}N_{b}, the PSIₖ test 322 is configured to test whether the observed distribution 406

$${\hat{p}}_{b} = \frac{{N}_{b}}{N}$$

represents an even distribution of the participant pool 202 members among a total number of experiment buckets B to which they are allocated, such that

$${\hat{p}}_{b} = \frac{1}{B} .$$

In this manner, the PSIₖ test 322 is derived from Equations 3-5.

$${PSI}_{k} = {\sum }_{0}^{B} ( \frac{{N}_{b}}{N} - \frac{1}{B} ) ( ln \frac{{N}_{b}}{N} - ln \frac{1}{B} ) \qquad ( Eq . 3 )$$

$${PSI}_{k} = \frac{1}{BN} {\sum }_{0}^{B} ( {BN}_{b} - N ) ln \frac{{BN}_{b}}{N} \qquad ( Eq . 4 )$$

$${PSI}_{k} \sim \frac{k + 1}{kN} {χ}_{B - 1}^{2} \qquad ( Eq . 5 )$$

Because a PSI statistic is known to follow a Chi-squared distribution for large sample counts N with B−1 degrees of freedom, the PSIₖ test 322 can be defined with a critical value of α=10% to designate an evaluation criteria according to Equation 6:

$${PSI}_{k} > \frac{k + 1}{kN} {χ}_{B - 1}^{2} \qquad ( Eq . 6 )$$

In this manner, the PSIₖ test 322 includes a distribution evaluation component 408 configured to evaluate whether the observed distribution 406 represents an expected distribution 410 for the experiment 302 as defined by the testing requirements 304 when evaluated using decision criteria 412, which is defined by a tuning parameter 414. For instance, the decision criteria 412 is represented by Equation 6, where the tuning parameter 414 is represented by k, such that the decision criteria 412 when the tuning parameter 414 is one becomes

$${PSI}_{1} > \frac{2}{N} {χ}_{B - 1}^{2} .$$

The randomization evaluation 124 output by applying the PSIₖ test 322 to single sample bucket 404 thus represents whether the observed distribution 406 represents an approximately uniform distribution of the participant pool 202 members allocated among B experiment buckets.

The distribution validation module 320 is configured to utilize the randomization evaluation 124 to output an alert 416 in response to determining that the observed distribution 406 does not represent the expected distribution 410 for the experiment being conducted. For instance, randomization problems arise due to various errors throughout the experiment pipeline, such as accidental overwriting of a first participant pool identifier with a second participant pool identifier, accidental inclusion of an additional participant in an experiment bucket, accidental exclusion of a participant from the experiment bucket, and so forth. Such errors result in randomization problems such as a single experiment participant being assigned to a first bucket that receives experimental data as well as a second bucket that receives control data, experiment buckets including more or fewer participants than intended, and the like. The alert 416 is thus representative of an indication output by the online experiment system 104 alerting an entity associated with the experiment to these randomization problems, as indicated by the randomization evaluation 124. In this manner, the PSIₖ test 322 enables the online experiment system 104 to actively monitor distributions of participant pool 202 members as allocated to different experiment buckets while an online experiment is ongoing and alert an entity conducting the experiment as to detected randomization issues that negatively affect a reliability of experiment results 122.

The randomization evaluation 124 generated using the PSIₖ test 322 demonstrates significant improvement relative to conventional approaches of detecting distribution anomalies, such as the Pearson Chi-square (χ²) test, the Kolmogorov-Smirnov (KS) test, and the Anderson-Darling (AD) test. To demonstrate these improvements, comparative tests were performed on the example datasets set forth below in Table 1. The first dataset represents no distribution anomalies, representative of participant pool members being evenly distributed among all buckets (i.e., all negative cases with no positive distribution anomalies). The second dataset represents some significant positive distribution anomalies determined based on the first dataset such that different buckets include different numbers of participant pool members. The third dataset represents simulated data that includes both negative and positive cases.

TABLE 1

| Dataset | Description |
|---|---|
| 1 | 306 experiment sample distributions evenly distributed among |
| | experiment buckets; all negative cases |
| 2 | 324 experiment sample distributions with 291 negative (evenly |
| | distributed) cases and 33 positive (uneven distribution) cases |
| | simulated based on the first dataset; positive and negative cases |
| 3 | 500 negative (evenly distributed) cases and 100 positive (uneven |
| | distribution anomalies) cases simulated using Multinomial |
| | distribution; positive and negative cases |

Construction of the second dataset to include some unevenly distributed cases is performed by mixing in an extra (0.05+x10⁻²)% of total sample counts into one bucket, with x˜Poisson(4)). Specifically, based on the total 324 experiment samples included in the second dataset, a positive case is created with some extra uneven samples for one experiment bucket, selected such that approximately 10% of the total 324 experiment sample distributions are positive cases and the rest negative cases.

In the third dataset, negative and positive cases are created based on a Multinomial distribution, such that each negative case is generated from a Multinomial distribution with

$${p}_{b} = \frac{1}{B}$$

for each bucket of a total of 100 buckets B, and a total sample size N˜Poisson(3×10⁶). Similarly, in the third dataset each positive case is generated from a Multinomial distribution, with one bucket's corresponding distribution probability being

$${p}_{b} = \frac{1}{B} + ( 0.05 + x {10}^{- 2} ) \%$$

with x˜Poisson(4)).

In comparing the PSIₖ test 322 with conventional approaches to detecting distribution anomalies using the first dataset of Table 1, analysis considers false positives produced by the various approaches, due to the first dataset including only negative cases. Analysis of the second and third datasets assesses false positives, false negatives, precision, and recall associated with the PSIₖ test 322 and each of the conventional approaches.

Results of the comparison for the first dataset are summarized below in Table 2, which reveals that the PSIₖ test 322 is associated with a 0% false positive rate while each conventional approach is associated with a false positive rate of >0%.

TABLE 2

| | X² Test | | AD Test | | KS Test | | PSIₖ₌₁ Test | |
|---|---|---|---|---|---|---|---|---|
| Dataset 1 | 0 | 1 | 0 | 1 | 0 | 1 | 0 | 1 |
| True Label 0 | 375 | 31 | 302 | 4 | 305 | 1 | 306 | 0 |

| | | | | |
|---|---|---|---|---|
| False Positive Rate | 10.13% | 1.31% | 0.33% | 0% |

Results of the comparison for the second dataset are summarized below in Table 3, which reveals that the PSIₖ test 322 has an overall F-score of 98.46% where the F-score indicates a measure of a test's accuracy. This F-score is significant because in implementations where the online experiment system 104 is simultaneously running hundreds of thousands of online experiments, even a single percentage point reduction in false positives enables an entity conducting the online experiments to identify and dedicate resources to addressing actual problems rather than wasting time analyzing false positives.

TABLE 3

| | X² Test | | AD Test | | KS Test | | PSIₖ₌₁ Test | |
|---|---|---|---|---|---|---|---|---|
| Dataset 2 | 0 | 1 | 0 | 1 | 0 | 1 | 0 | 1 |
| True Label 0 | 261 | 30 | 287 | 4 | 290 | 1 | 291 | 0 |
| True Label 1 | 0 | 33 | 3 | 30 | 3 | 30 | 1 | 32 |

| | | | | |
|---|---|---|---|---|
| False Positive Rate | 10.13% | 1.37% | 0.34% | 0% |
| Precision | 52.38% | 88.24% | 96.77% | 100% |
| Recall | 100% | 90.11% | 90.91% | 96.97% |
| F-Score | 68.75% | 89.55% | 93.75% | 98.46% |

Results of the comparison for the third dataset are summarized below in Table 4, which describes how the PSIₖ test 322 achieved perfect results.

TABLE 4

| | X² Test | | AD Test | | KS Test | | PSIₖ₌₁ Test | |
|---|---|---|---|---|---|---|---|---|
| Dataset 3 | 0 | 1 | 0 | 1 | 0 | 1 | 0 | 1 |
| True Label 0 | 447 | 53 | 494 | 6 | 496 | 4 | 500 | 0 |
| True Label 1 | 0 | 100 | 22 | 78 | 27 | 73 | 0 | 100 |

| | | | | |
|---|---|---|---|---|
| False Positive Rate | 10.60% | 1.20% | 0.80% | 0% |
| Precision | 65.36% | 92.86% | 94.81% | 100% |
| Recall | 100% | 78.00% | 73.00% | 100% |
| F-Score | 79.05% | 84.78% | 82.49% | 100% |

An influence of the tuning parameter 414 used in the PSIₖ test 322 is summarized below in Table 5, which demonstrates how the tuning parameter 414 can improve performance of the PSIₖ₌₁ test. Specifically, with the tested datasets, a tuning parameter 414 of two, three, or four identified all positive cases without generating any false positives.

TABLE 5

| | PSIₖ | | | | | | | |
|---|---|---|---|---|---|---|---|---|
| Data-set | Test | k = l | k = 2 | k = 3 | k = 4 | k = 5 | k = 6 | k = 7 |
| 1 | False | 0.00% | 0.00% | 0.00% | 0.00% | 0.33% | 0.33% | 0.98% |
| | Positive | | | | | | | |
| | Rate | | | | | | | |
| 2 | False | 0.00% | 0.00% | 0.00% | 0.00% | 0.34% | 0.34% | 1.03% |
| | Positive | | | | | | | |
| | Rate | | | | | | | |
| | Precision | 100% | 100% | 100% | 100% | 97.06% | 97.06% | 91.67% |
| | Recall | 96.97% | 100% | 100% | 100% | 100% | 100% | 100% |
| 3 | False | 0.00% | 0.00% | 0.00% | 0.00% | 0.00% | 0.20% | 0.60% |
| | Positive | | | | | | | |
| | Rate | | | | | | | |
| | Precision | 100% | 100% | 100% | 100% | 100% | 99.01% | 97.09% |
| | Recall | 100% | 100% | 100% | 100% | 100% | 100% | 100% |

Having considered example systems and techniques for generating a randomization evaluation describing whether testing groups represent a desired distribution of experiment participants, consider now example procedures to illustrate aspects of the techniques described herein.

Example Procedures

The following discussion describes techniques that are configured to be implemented utilizing the previously described systems and devices. Aspects of each of the procedures are configured for implementation in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-4.

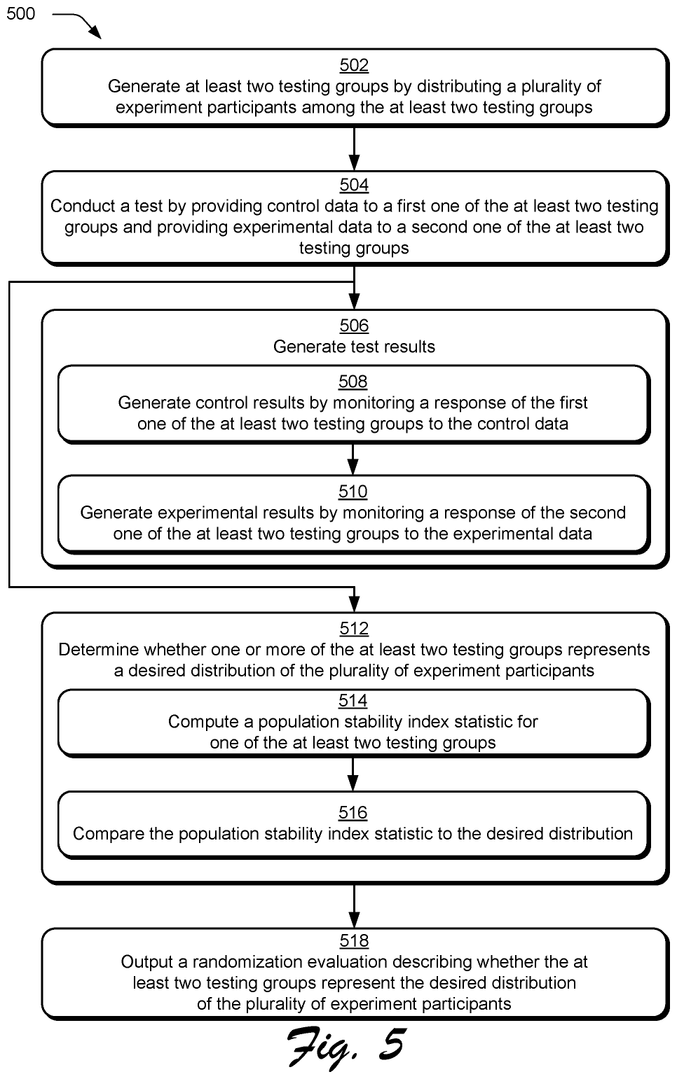

FIG. 5 depicts a procedure 500 in an example implementation of a computing device outputting a randomization evaluation describing whether testing groups represent a desired distribution of experiment participants. To begin, at least two testing groups are generated by distributing a plurality of experiment participants among the at least two testing groups (block 502). The randomization module 306 of the online experiment system 104, for instance, utilizes the randomization algorithm 308 to distribute computing devices 110 included in the participant pool 202 among bucket 310, bucket 312, bucket 314, and bucket 316.

A test is then conducted by providing control data to a first one of the at least two testing groups and providing experimental data to a second one of the at least two testing groups (block 504). The testing module 318, for instance, provides control data 106 and experimental data 108 to experiment participants according to testing requirements 304 of the experiment 302, such as providing control data 106 to experiment participants included in bucket 310 and bucket 314 and providing experimental data 108 to experiment participants included in bucket 312 and bucket 316.

Test results are then generated (block 506). The online experiment system 104, for instance generates experiment results 122. As part of generating the test results, control results are generated by monitoring a response of the first one of the at least two testing groups to the control data (block 508) and experimental results are generated by monitoring a response of the second one of the at least two testing groups to the experimental data (block 510). The testing module 318, for instance, monitors and records a response of experiment participants included in the buckets 310 and 314 to the control data 106 as control results 118. Similarly, the testing module 318 monitors and records a response of experiment participants included in the buckets 312 and 316 to the experimental data 108 as experimental results 120. The online experiment system 104 then aggregates the control results 118 and the experimental results 120 as the experiment results 122.

While the test results are being generated, a determination of whether one or more of the at least two testing groups represents a desired distribution of the plurality of experiment participants is made (block 512). This performance of the operations described in block 512 is represented by the arrow proceeding from block 504 to block 512 while circumventing block 506. The distribution validation module 320, for instance, implements the PSIₖ test 322 to generate a randomization evaluation 124 for one of the buckets generated by the randomization module 306.

As part of determining whether one or more of the at least two testing groups represents the desired distribution of the plurality of experiment participants, a population stability index statistic is computed for one of the at least two testing groups (block 514) and the population stability index statistic is compared to the desired distribution (block 516). The distribution sample component 402, for instance, generates an observed distribution 406 for a single sample bucket 404 and uses the observed distribution 406 to compute a population stability index statistic according to Equation 4. The distribution evaluation component 408 then compares the observed distribution 406 to the expected distribution 410 defined by testing requirements 304 for the experiment according to the decision criteria 412 set forth in Equation 6, as defined by the tuning parameter 414.

A randomization evaluation is the output describing whether the at least two testing groups represents the desired distribution of the plurality of experiment participants (block 518). The distribution evaluation component 408, for instance, outputs a result of the comparison of the observed distribution 406 to the expected distribution 410 using the decision criteria 412 and the tuning parameter 414 as the randomization evaluation 124. In some implementations, in response to detecting that the randomization evaluation 124 indicates that the observed distribution 406 does not match the expected distribution 410, the online experiment system 104 is configured to output an alert 416, indicating a randomization problem, while the experiment is ongoing.

Having described example procedures in accordance with one or more implementations, consider now an example system and device to implement the various techniques described herein.

Example System and Device

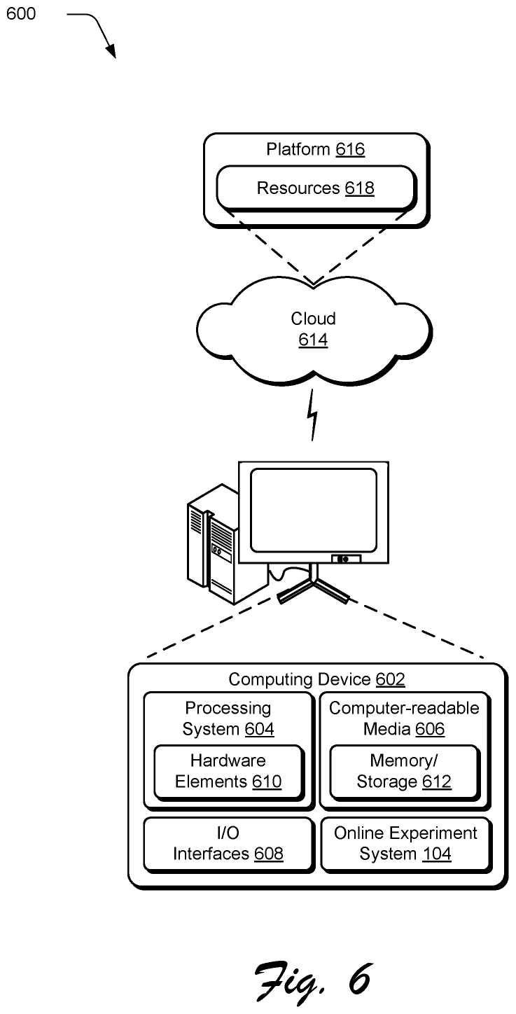

FIG. 6 illustrates an example system 600 that includes an example computing device 602, which is representative of one or more computing systems and/or devices that implement the various techniques described herein. This is illustrated through inclusion of the online experiment system 104. The computing device 602 is configured, for example, as a service provider server, as a device associated with a client (e.g., a client device), as an on-chip system, and/or as any other suitable computing device or computing system.

The example computing device 602 as illustrated includes a processing system 604, one or more computer-readable media 606, and one or more I/O interface 608 that are communicatively coupled, one to another. Although not shown, the computing device 602 is further configured to include a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that are configurable as processors, functional blocks, and so forth. For instance, hardware element 610 is implemented in hardware as an application specific integrated circuit or other logic device formed using one or more semiconductors. The hardware elements 610 are not limited by the materials from which they are formed or the processing mechanisms employed therein. For example, processors are alternatively or additionally comprised of semiconductor(s) and/or transistors (e.g., electronic integrated circuits (ICs)). In such a context, processor-executable instructions are electronically executable instructions.

The computer-readable storage media 606 is illustrated as including memory/storage 612. The memory/storage 612 represents memory/storage capacity associated with one or more computer-readable media. The memory/storage 612 is representative of volatile media (such as random-access memory (RAM)) and/or nonvolatile media (such as read only memory (ROM), Flash memory, optical disks, magnetic disks, and so forth). The memory/storage 612 is configured to include fixed media (e.g., RAM, ROM, a fixed hard drive, and so on) as well as removable media (e.g., Flash memory, a removable hard drive, an optical disc, and so forth). In certain implementations, the computer-readable media 606 is configured in a variety of other ways as further described below.

Input/output interface(s) 608 are representative of functionality to allow a user to enter commands and information to computing device 602, and allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., a device configured to employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 is representative of a variety of hardware configurations as further described below to support user interaction.

Various techniques are described herein in the general context of software, hardware elements, or program modules. Generally, such modules include routines, programs, objects, elements, components, data structures, and so forth that perform particular tasks or implement particular data types. The terms “module,” “functionality,” and “component” as used herein generally represent software, firmware, hardware, or a combination thereof. The features of the techniques described herein are platform-independent, meaning that the techniques are configured for implementation on a variety of commercial computing platforms having a variety of processors.

An implementation of the described modules and techniques are stored on or transmitted across some form of computer-readable media. The computer-readable media include a variety of media that is accessible by the computing device 602. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information for access by a computer.

“Computer-readable signal media” refers to a signal-bearing medium that is configured to transmit instructions to the hardware of the computing device 602, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that is employed in some embodiments to implement at least some aspects of the techniques described herein, such as to perform one or more instructions. Hardware, in certain implementations, includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are employed to implement various techniques described herein. Accordingly, software, hardware, or executable modules are implemented as one or more instructions and/or logic embodied on some form of computer-readable storage media and/or by one or more hardware elements 610. The computing device 602 is configured to implement instructions and/or functions corresponding to the software and/or hardware modules. Accordingly, implementation of a module that is executable by the computing device 602 as software is achieved at least partially in hardware, e.g., through use of computer-readable storage media and/or hardware elements 610 of the processing system 604. The instructions and/or functions are executable/operable by one or more articles of manufacture (for example, one or more computing devices 602 and/or processing systems 604) to implement techniques, modules, and examples described herein.

The techniques described herein are supported by various configurations of the computing device 602 and are not limited to the specific examples of the techniques described herein. This functionality is further configured to be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 include applications and/or data that is utilized while computer processing is executed on servers that are remote from the computing device 602. Resources 618 also include services provided over the Internet and/or through a subscriber network, such as a cellular or Wi-Fi network.

The platform 616 is configured to abstract resources and functions to connect the computing device 602 with other computing devices. The platform 616 is further configured to abstract scaling of resources to provide a corresponding level of scale to encountered demand for the resources 618 that are implemented via the platform 616. Accordingly, in an interconnected device embodiment, implementation of functionality described herein is configured for distribution throughout the system 600. For example, in some configurations the functionality is implemented in part on the computing device 602 as well as via the platform 616 that abstracts the functionality of the cloud 614.

### CONCLUSION

Although the invention has been described in language specific to structural features and/or methodological acts, the invention defined in the appended claims is not necessarily limited to the specific features or acts described. Rather, the specific features and acts are disclosed as example forms of implementing the claimed invention.

What is claimed is:

1. A computer-implemented method, comprising:
generating at least two testing groups by distributing a plurality of user profiles among the at least two testing groups;
conducting a test by providing control data to a first one of the at least two testing groups and providing experimental data to a second one of the at least two testing groups;
monitoring a response of the first one of the at least two testing groups to the control data and a response of the second one of the at least two testing groups to the experimental data;
during the monitoring and prior to generating a report that describes the response of the first one of the at least two testing groups and the response of the second one of the at least two testing groups, determining whether the at least two testing groups represent a desired distribution of the plurality of user profiles by computing a population stability index (PSI) statistic for one of the at least two testing groups; and
generating the report that describes the response of the first one of the at least two testing groups and the response of the second one of the at least two testing groups.

2. The computer-implemented method of claim 1, wherein conducting the test comprises outputting a user interface for an application or a website, wherein the control data comprises a first version of the user interface and the experimental data comprises a second version of the user interface that is different from the first version of the user interface.

3. The computer-implemented method of claim 1, wherein determining whether the at least two testing groups represents the desired distribution of the plurality of user profiles is performed without computing a PSI statistic for another one of the at least two testing groups.

4. The computer-implemented method of claim 1, wherein computing the PSI statistic for the one of the at least two testing groups is performed using a tuning parameter that represents a ratio of a number of user profiles included in the first one of the at least two testing groups to the second one of the at least two testing groups.

5. The computer-implemented method of claim 4, wherein the tuning parameter comprises an integer value of two, three, or four.

6. The computer-implemented method of claim 1, further comprising generating an alert to redistribute the plurality of user profiles among the at least two testing groups responsive to determining that the at least two testing groups fails to represent the desired distribution of the plurality of user profiles.

7. The computer-implemented method of claim 1, wherein the report describes a distribution of the plurality of user profiles among the at least two testing groups.

8. The computer-implemented method of claim 1, wherein distributing the plurality of user profiles among the at least two testing groups is performed using a randomization algorithm.

9. The computer-implemented method of claim 1, wherein the desired distribution comprises an equal number of the plurality of user profiles included in each of the at least two testing groups.

10. The computer-implemented method of claim 1, wherein the desired distribution comprises a different number of the plurality of user profiles included in each of the at least two testing groups.

11. A system comprising:
one or more processors; and
a computer-readable storage medium storing instructions that are executable by the one or more processors to perform operations comprising:
randomly distributing a plurality of experiment participants into at least two testing groups;
conducting a test by providing control data to a first one of the at least two testing groups and experimental data to a second one of the at least two testing groups;
monitoring a response of the first one of the at least two testing groups to the control data and a response of the second one of the at least two testing groups to the experimental data;
during the monitoring, determining whether a subset of the experiment participants included in the first one of the at least two testing groups or the second one of the at least two testing groups represents a desired distribution of the experiment participants by computing a population stability index (PSI) statistic for the first one of the at least two testing groups or the second one of the at least two testing groups; and
generating a report that describes whether the subset of the experiment participants represents the desired distribution of the experiment participants.

12. The system of claim 11, wherein conducting the test comprises outputting a user interface for an application or a website and the control data comprises a first version of the user interface and the experimental data comprises a second version of the user interface that is different from the first version of the user interface.

13. The system of claim 11, wherein computing the PSI statistic for the first one of the at least two testing groups or the second one of the at least two testing groups is performed using a tuning parameter that represents a ratio of a number of the experiment participants included in the first one of the at least two testing groups to a number of the experiment participants included in the second one of the at least two testing groups.

14. The system of claim 11, the operations further comprising generating an alert recommending redistribution of the experiment participants responsive to determining that the subset of the experiment participants fails to represent the desired distribution of the experiment participants.

15. The system of claim 11, wherein the desired distribution comprises an equal number of the experiment participants included in each of the at least two testing groups.

16. The system of claim 11, wherein the desired distribution comprises a different number of the experiment participants included in different ones of the at least two testing groups.

17. A computer-readable storage medium comprising instructions that are executable by one or more computing devices to perform operations comprising:
generating at least two testing groups by distributing a plurality of user profiles among the at least two testing groups;
conducting a test by providing control data to a first one of the at least two testing groups and providing experimental data to a second one of the at least two testing groups;
monitoring a response of the first one of the at least two testing groups to the control data and a response of the second one of the at least two testing groups to the experimental data;
during the monitoring and prior to generating a report that describes the response of the first one of the at least two testing groups and the response of the second one of the at least two testing groups, determining whether the at least two testing groups represents a desired distribution of the plurality of user profiles by computing a population stability index (PSI) statistic for one of the at least two testing groups; and
generating the report that describes the response of the first one of the at least two testing groups and the response of the second one of the at least two testing groups.

18. The computer-readable storage medium of claim 17, wherein computing the PSI statistic for the one of the at least two testing groups is performed using a tuning parameter that represents a ratio of a number of user profiles included in the first one of the at least two testing groups to the second one of the at least two testing groups.

19. The computer-readable storage medium of claim 18, wherein the tuning parameter comprises an integer value of two, three, or four.

20. The computer-readable storage medium of claim 17, wherein distributing the plurality of user profiles among the at least two testing groups is performed using a randomization algorithm.
